(19) United States
(12) Patent Application Publication
(10) Pub. No.: US 2023/0296124 A1
(43) Pub. Date: Sep. 21, 2023

(54) Fastener system which provides temporary mounting of usable foriegn objects to a device or structure

(71) Applicant: Dudley Scott Baesler, Ponte Vedra, FL (US)

(72) Inventor: Dudley Scott Baesler, Ponte Vedra, FL (US)

(73) Assignee: Dudley Scott Baesler, Ponte Vedra, FL (US)

(21) Appl. No.: 17/803,217

(22) Filed: Mar. 21, 2022

(51) Int. Cl. F16B 33/00; F16B 23/00

(52) U.S. Cl. CPC F16B 33/008; F16B 23/00

(57) ABSTRACT

Mounting items such as Downrigger and functionable frames to boat transoms as well as other objects has been accomplished in the past with full permanent mounts. These mounts detract from the aesthetics of the boat or other vehicle as well as take up physical space on a gunnel which is often used by guest. The fastener proposed for this allows the temporary mounting of different items with the permanent mounting of the fastener. This fastener is also corrosion proof and strong as to support the different functions it could encounter.

### BACKGROUND OF THE INVENTION

### 1. Field of the Invention

This invention applies to marine fastening systems which can resist corrosion. In general it can be mounted in one or multiple locations to grant mounting of different items to the boat or other structure.

### 2. Description of the Related Art

Currently, most all mounts are fastened directly to the location such as a boat gunnel thereby creating an obstacle on the boat or vehicle itself. Parts of this fastener of discussion are 1) a stylish mount head, 2) a head which when unattached to foreign accessories provides comfortable interaction with people, 3) two flats making the head wrench accessible for bolt tightening, 4) a threaded fastening system for the boat mounting, and 5) a interior threaded system with drain hole for the attachment of fasteners from whatever device is mounted. The exterior thread for the mounting will be a standard lock nut which is not part of this art.

### SUMMARY OF THE INVENTION

The present invention is a metal (metal chosen to application) Fastener which has a function ornamental head, low profile, and has a lower threaded base for secure mounting. The interior of the fastener has a threaded center to accept the required screw or bolt from the object to be temporarily mounted. Fasteners can be used as single or group.

Fastener Head—Can be any shape, preferably flat, that is ornamental yet has two flats to allow restraint during tightening. Head is smooth and can have contact with the human body, such as when sitting upon, that is comfortable and does not cause injury.

External Mount Threaded Hole—This hole can be any thread diameter which does not thin the wall of the overall fastener.

Drain Hole—This is a continuation of the External Mount Threaded Hole which allows fluids to drain.

Threaded Exterior Shaft—This is the threaded side of the fastener which can be any diameter as long as it is larger than the External mount Thread hole. This is threaded to allow the use of a nut, preferably lock nut, and even a washer to mount the fastener to the permanent location.

### BRIEF DESCRIPTION OF THE DRAWINGS

FIG. 1 is a drawing depicting the fastener in whole using measurements as example only. In this case, parts of this fastener in the figure are 1) a stylish mount head, 2) two flats making the head wrench accessible for bolt tightening, 3) A head which is smooth in a way, such as beveled, to promote comfortable interaction with people 4) a threaded fastening system for the boat mounting, and 5) a interior threaded system with drain hole for the attachment of fasteners from whatever device is mounted. The exterior thread for the mounting will be a standard lock nut which is not part of this art.

### DETAILED DESCRIPTION

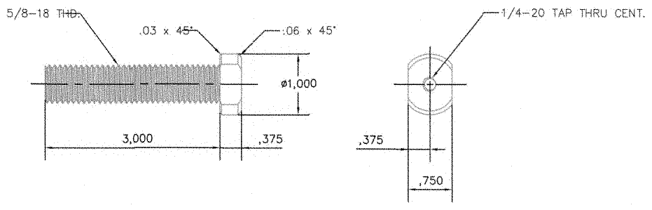

The present invention will now be described with reference to the diagram of FIG. 1, which depicts the following principal elements of the fastener. Of course, it will be appreciated by those skilled in the art that a variety of modifications and changes in the fastener can be undertaken without departing from the spirit and scope of this invention.

The component parts of the system and process include the following:
1. Fastener Head—Can be any shape, preferably flat, that is ornamental yet has two flats to allow restraint during tightening and a shaping which promotes comfortable interaction with people. The object is to provide a comfortable head with no obstruction or change in the aesthetics of the mounting area
2. External Mount Threaded Hole—This hole can be any thread diameter which does not thin the wall of the overall fastener.
3. Drain Hole—This is a continuation of the External Mount Threaded Hole which allows fluids to drain.
4. Threaded Exterior Shaft—This is the threaded side of the fastener which can be any diameter as long as it is larger than the External mount Thread hole. This is threaded to allow the use of a nut, preferably lock nut, and even a washer to mount the fastener to the permanent location.

### Objects in the Invention

A first object of the invention is to allow the user to eliminate the mounting of bulky supplemental items to their structure. The second object of the invention is to allow removal of these foreign objects when that space is required for another function. The third object of the invention is to provide an aesthetically pleasing permanent mount for foreign objects of use which can comfortably interact with people such as when sitting upon.

What is claimed is:

1. A fastener with external and internal threaded areas for mounting

2. A fastener of claim (1) which has an aesthetically pleasing low volume exposed head

3. A fastener of claim (1) which is contoured as such to give comfortable interaction with people

4. A fastener of claim (1) which can be manufactured out of any metal which meets the environment requirements of that functioning space.

5. A fastener of claim (1) which can be manufactured with and interior thread size of any diameter both imperial or metric as long as it does not thin the wall or exceed the wall of the exterior thread.

6. A fastener of claim (1) which has an exterior diameter of the mounting thread which can be any size provided it is larger than the interior threaded and minimizes the footprint of the fastener.

7. A fastener of claim (1) which has an operable drain hole in the center to not allow accumulation of foreign matter or fluids within the fastener itself.
